(19) United States
(12) Patent Application Publication
(10) Pub. No.: US 2005/0234808 A1
(43) Pub. Date: Oct. 20, 2005

(54) Method of joint purchase reverse auction, computer program product and server

(75) Inventors: Seiji Goto, Tokyo (JP); Satoshi Okada, Tokyo (JP); Katsuhisa Furuichi, Tokyo (JP); Masazumi Yoshikawa, Tokyo (JP); Hitomi Matsumoto, Tokyo (JP)

Correspondence Address: EDWARDS & ANGELL, LLP, P.O. BOX 55874, BOSTON, MA, 02205, US

(73) Assignee: DeeCorp Limited, Tokyo (JP)

(21) Appl. No.: 11/107,677

(22) Filed: Apr. 14, 2005

(30) Foreign Application Priority Data
Apr. 14, 2004 (JP) 2004-118654

(51) Int. Cl. G06F 17/60

(52) U.S. Cl. 705/37

(57) ABSTRACT

A reverse auction method implemented by a server connected to a plurality of buyer terminals and a plurality of supplier terminals through a network. The method selects desired purchase terms as candidates forjoint purchase from desired purchase terms received from the plurality of buyer terminals, and transmits an invitation to participate in joint purchase to a buyer terminal of a buyer corresponding to at least the selected desired purchase terms. Then, the method receives a participation response to the invitation from a buyer terminal of a buyer intending to participate in reverse auction and determining a combination of buyers participating in joint purchase according to the participation response.

### BACKGROUND OF THE INVENTION

1. Field of the Invention

The present invention relates to a reverse auction system through a communication network and particularly to a joint purchase reverse auction system which conducts reverse auction according to desired purchase terms that puts together purchase desires of a plurality of buyers and determines a successful supplier.

2. Description of Related Art

Electronic purchase services that procure a product or service over the internet becomes common. Recently, B-to-B service that is intended for business-to-business transaction, not only B-to-C service that targets general consumers, is on the increase. One form of the electronic purchase service is a reverse auction service.

The reverse auction service starts upon buyer's presentation of desired purchase terms such as specifications of desired product, price, quantity, and delivery date, delivery place. In this auction, suppliers who can satisfy the buyer's terms of purchase submit their bids. This is called “reverse auction” because roles of supplier and buyer are opposite from a normal auction called forward auction in which buyers submit bids in order to obtain a product presented by a supplier. The reverse auction is suitable for business-to-business transaction since terms of purchase such as desired specifications, delivery date, and delivery method vary by buyer in many cases.

The reverse auction service involves one-on-one reverse auction and joint purchase reverse auction. The one-on-one reverse auction conducts reverse auction based on a single buyer's purchase desire and determines a single successful supplier. The joint purchase reverse auction, on the other hand, conducts reverse auction for a total procurement amount that puts together purchase desires of a plurality of buyers and determines a successful supplier. The joint purchase reverse auction has an advantage of profiting volume merit even if the procurement amount of each buyer is small. Japanese Unexamined Patent Publication No. 2001-319098 (Takada) and Japanese Unexamined Patent Publication No. 2002-109286 (Hikita) disclose a system for the joint purchase reverse auction.

The reverse auction system taught by Takada is as follows. First, a supplier registers product information with a specified selling price and quantity to the system so as to present the product information to buyers. The system then receives intent to purchase the presented product from a plurality of buyers. After that, the system starts reverse auction by setting the intent of the plurality of buyers as a joint purchase offer. The system then receives bids or selling terms for the joint purchase offer from suppliers and determines a supplier who finally submits the best selling terms, which is the lowest price, as a successful bidder.

The reverse auction system taught by Hikita is as follows. First, a supplier registers information on a selling product to the system. Then, a buyer selects a product from a product list registered by suppliers and inputs a desired quantity and price through a terminal. The system counts purchase intents inputted by a plurality of buyers for the same product and starts reverse auction for the total product quantity and desired price. Suppliers bid the price down for the terms of purchase that puts together purchase intents of a plurality of buyers, and a supplier who bids the lowest price makes a successful bid.

The above conventional systems for joint purchase reverse auction have two problems. One is that it is difficult to make a joint purchase case by putting together a plurality of buyers who have similar purchase desires and will be benefited by joint purchase upon occurrence of a desire to purchase by a buyer.

The other problem is that it is difficult to conduct the joint purchase that puts together desires to purchase different products or services. As described earlier, terms of purchase such as desired specifications, delivery date, and delivery method often vary by buyer in the business-to-business transaction. Therefore, a need exists for a method and system that are effective for joint purchase of different kinds of products or services.

The systems disclosed by Takada and Hikita conduct joint purchase reverse auction after collecting a plurality of buyers who desire to purchase a product or service which is registered as a joint purchase object by a supplier. It is thereby impossible to determine the advisability of making joint purchase and allow a joint purchase case to occur upon occurrence of purchase desires by buyers.

Further, the above systems make joint purchase when a plurality of buyers desire to purchase the same product which is registered by a supplier, and it does not makes joint purchase by putting together desires to purchase different products or services.

### SUMMARY OF THE INVENTION

The present invention has been accomplished to solve the above problems and an object of the present invention is thus to provide a joint purchase reverse auction method capable of generating a joint purchase case upon occurrence of a desire to purchase by a buyer and making joint purchase of different kinds of products and services, a computer program product for causing a computer to execute this method, and a server.

According to one aspect of the present invention, there is provided a reverse auction method implemented by a server connected to a plurality of buyer terminals and a plurality of supplier terminals through a network. The method includes selecting desired purchase terms as candidates for joint purchase from desired purchase terms received from the plurality of buyer terminals; transmitting an invitation to participate in joint purchase to a buyer terminal of a buyer corresponding to at least the selected desired purchase terms; and receiving a participation response to the invitation from a buyer terminal of a buyer intending to participate in reverse auction and determining a combination of buyers participating in joint purchase according to the participation response. This method allows generating a joint purchase case upon occurrence of a desire to purchase by a buyer and conducting joint purchase reverse auction for different kinds of products or services.

It is preferred that the desired purchase terms at least include information indicating a classification of a product/service and information indicating a desired time to hold a reverse auction, and the desired purchase terms are selected as candidates for joint purchase according to the information indicating a classification of a product/service and the information indicating a desired time to hold a reverse auction. This allows effectively putting together the cases based on the identity and similarity of a product classification even if a product or service to be procured is different, thereby conducting the joint purchase reverse auction.

The desired purchase terms may at least include information indicating a classification of a product/service, and desired purchase terms with the same product/service classification may be selected as candidates for joint purchase.

The desired purchase terms may at least include information indicating a desired quantity of a product/service, and desired purchase terms may be selected as candidates for joint purchase according to the information indicating a quantity of a product/service so as to increase prosecution quantity in joint purchase.

The reverse auction method may further include transmitting the desired purchase terms received form the plurality of buyer terminals to the supplier terminals and receiving a participation response of a supplier intending to participate in reverse auction from the supplier terminals, wherein desired purchase terms are selected as candidates for joint purchase according to the participation, response of the supplier. This allows generating a joint purchase case upon occurrence of a desire to purchase by a buyer and conducting joint purchase reverse by effectively putting together the cases based on overlap of participating suppliers even if a product or service to be procured is different.

The invitation to participate in joint purchase may be transmitted to all the buyer terminals. Transmitting an invitation to participate in joint purchase to many buyers allows spurring demand of potential buyers, thereby increasing a possibility to effectively conduct joint purchase when the number of participating buyers is expected to be small.

The reverse auction method may further include transmitting an approval request for joint purchase to a buyer terminal of a buyer included in the combination of buyers participating in joint purchase; and receiving an approval for joint purchase from the buyer terminal and updating a combination of buyers participating in joint purchase according to the approval. This allows confirming a buyer's intent to participate in joint purchase reverse auction and leaving the approval of the buyer in the server 1, thereby enhancing the credibility of the joint purchase reverse auction.

According to another aspect of the present invention, there is provided a computer program product for causing a computer connected to a plurality of buyer terminals and a plurality of supplier terminals through a network to execute a process of reverse auction 1. The computer program product includes a computer readable medium storing a program code. The program code includes a first program code selecting desired purchase terms as candidates for joint purchase from desired purchase terms received from the plurality of buyer terminals; a second program code transmitting an invitation to participate in joint purchase to a buyer terminal of a buyer corresponding to at least the desired purchase terms selected by the first program code; and a third program code determining a combination of buyers participating in joint purchase according to a participation response to the invitation received from a buyer terminal of a buyer intending to participate in reverse auction.

According to yet another aspect of the present invention, there is provided a server connected to a plurality of buyer terminals and a plurality of supplier terminals through a network for implementing reverse auction. The server includes a joint purchase candidate selection unit selecting desired purchase terms as candidates for joint purchase from desired purchase terms received from the plurality of buyer terminals; an invitation transmission unit transmitting an invitation to participate in joint purchase to a buyer terminal of a buyer corresponding to at least the desired purchase terms selected by the joint purchase candidate selection unit; and a determination unit determining a combination of buyers participating in joint purchase according to a participation response to the invitation received from a buyer terminal of a buyer intending to participate in reverse auction.

Use of the computer program product of the present invention to cause a computer to operate or use of the server of the present invention allows generating a joint purchase case upon occurrence of a desire to purchase by a buyer and conducting joint purchase reverse auction for different kinds of products or services.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a block diagram showing the entire configuration of a reverse auction system of the present invention;

FIG. 2 is a block diagram of a server;

FIG. 3 is a view showing an example of a buyer information table;

FIG. 4 is a view showing an example of a supplier information table;

FIG. 5 is a view showing an example of a desired purchase terms table;

FIG. 6 is a view showing an example of a joint purchase case table;

FIG. 7 is a flowchart showing the process of a reverse auction system of the present invention;

FIG. 8 is a flowchart showing a joint purchase candidate selection routine of the present invention;

FIG. 9 is a flowchart showing the process of a reverse auction system of the present invention;

FIG. 10 is a flowchart showing a joint purchase candidate selection routine of the present invention;

FIG. 11 is a view showing an example of a desired purchase terms input screen;

FIG. 12 is a view showing an example of a desired purchase terms input screen;

FIG. 13 is a process flow diagram of a joint purchase candidate selection routine of the present invention;

FIGS. 14A to 14E are views to explain specific examples of a joint purchase candidate selection routine of the present invention;

FIGS. 15A to 15E are views to explain specific examples of a joint purchase candidate selection routine of the present invention; and

FIGS. 16A to 16E are views to explain specific examples of a joint purchase candidate selection routine of the present invention.

### DESCRIPTION OF THE PREFERRED EMBODIMENTS

Preferred embodiments of the present invention are described hereinafter with reference to the drawings.

First Embodiment

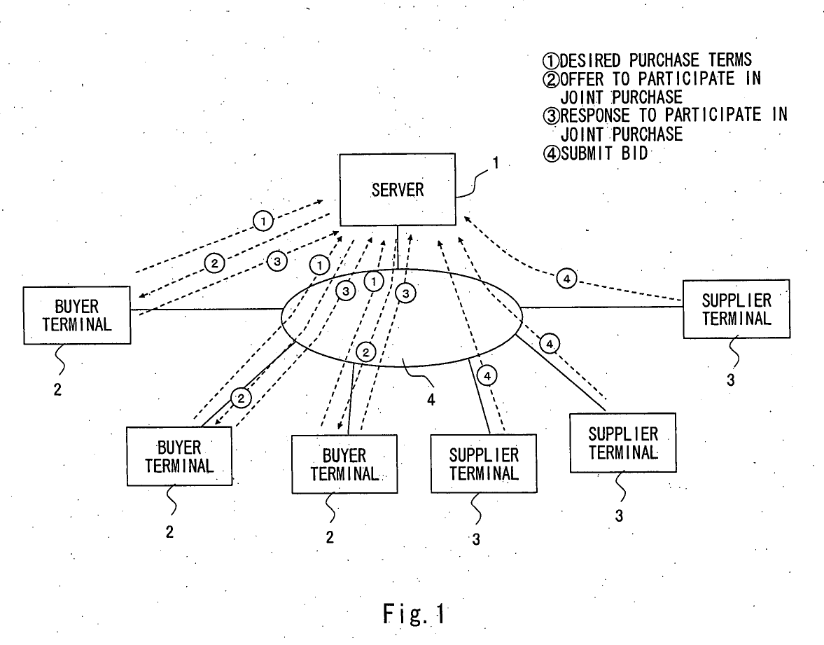

FIG. 1 is the block diagram showing the entire configuration of a reverse auction system according to a first embodiment of the invention. The system includes a server 1, at least one buyer terminal 2, and at least one supplier terminal 3, which are connected through a network 4.

The server 1 acquires and controls desired purchase terms transmitted from the buyer terminal 2, bidding information transmitted from the supplier terminal 3, and so on, and conducts reverse auction. The buyer terminal 2 is a terminal used by a buyer who is a user of a reverse auction service. The supplier terminal 3 is a terminal used by a supplier who is a user of the reverse auction service. The buyer is a purchaser who desires to procure a product or service through the use of the reverse auction service. The supplier is a seller who desires to offer a product or service through the use of the reverse auction service. The following description describes the case where an object of procurement in the reverse auction is a product.

Referring to first FIG. 1, an overview of the operation of the reverse auction system of this embodiment is described. Firstly in this system, a plurality of buyer terminals 2 transmit to the server 1 the desired purchase terms for a product or service they desire to procure in the reverse auction. The desired purchase terms are data including a desired product, desired quantity, desired unit price, and desired reverse auction period.

Then, the server 1 compares the received desired purchase terms to select the desired purchase terms which are similar in the desired product, desired reverse auction period and so on. The server 1 then gives notice of invitation to participate in joint purchase to the buyer terminals 2 which have transmitted the selected desired purchase terms.

The buyer who intends to participate in the joint purchase transmits a participation response from the buyer terminal 2 to the server 1. Receiving the participation response, the server 1 puts together desired product, desired quantity, desired unit price, desired reverse auction period and so on according to the desired purchase terms of the buyers who intend to participate in the joint purchase, thereby determining joint purchase reverse auction starting terms, which are referred to hereafter as “joint purchase starting terms”.

The server 1 then transmits the joint purchase starting terms to the supplier terminals 3 so as to notify the terms to the suppliers, thereby conducting the reverse auction. The reverse auction receives bids from the supplier terminals 3 and finally determines a successful supplier. It is thereby possible to conduct the joint purchase reverse auction in which a joint purchase case is generated upon occurrence of a desire to purchase by a buyer.

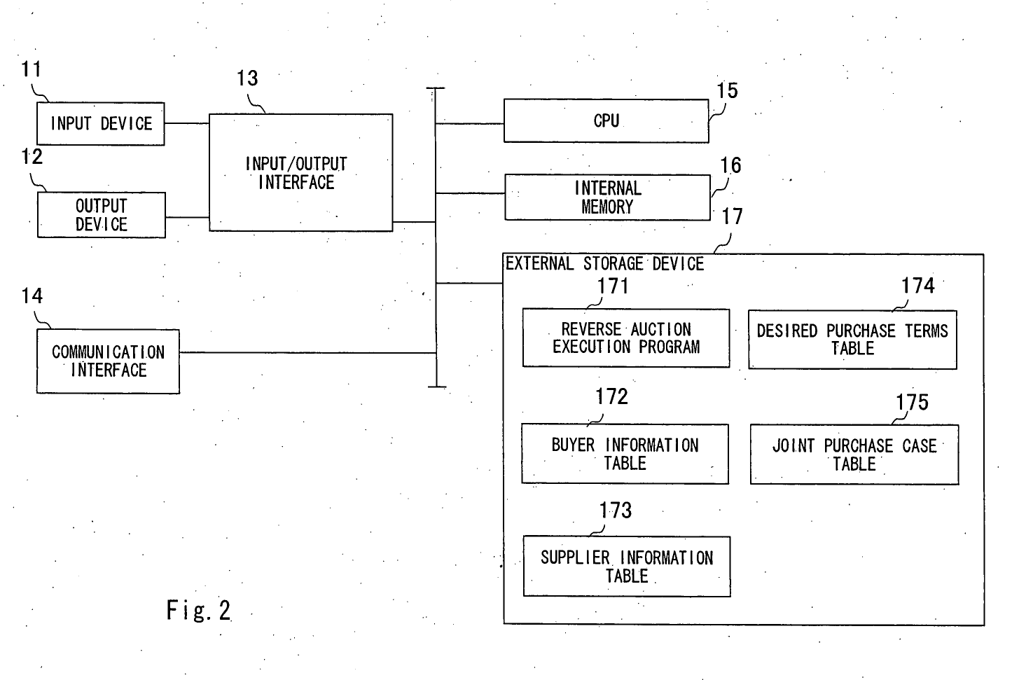

Referring next to FIG. 2, the hardware configuration of the server 1 is shown. The server 1 may be composed of a typical computer system. For example, the server 1 includes an input device 11 such as a keyboard and mouse, an output device 12 such as a monitor and a printer, an input/output interface 13 for controlling their input and output, and a communication interface 14 for transmitting and receiving data through a network such as LAN, telephone network, packet exchange network. The server 1 further includes a CPU 15 for executing arithmetic processing, an internal memory 16, and an external storage device 17. The external storage device 17 maybe a hard disk device, for example.

The CPU 15 is a central control unit that executes each processing in the server 1 according to control program. The control program is a program for causing the CPU 15 to execute the processing on the server 1, and it is stored in the internal memory 16 or the external storage device 17. The program may be acquired from remote storage means through the communication network.

The external storage device 17 stores a reverse auction execution program 171. It also stores a buyer information table 172, a supplier information table 173, a desired purchase terms table 174, and a joint purchase case table 175.

The reverse auction execution program 171 is a program for causing the computer system to execute the process of the reverse auction method of the invention. It is loaded to the internal memory 16 and executed on the CPU 15. The CPU 15 operates according to the reverse auction execution program 171, thereby allowing the computer system to operate as the server 1 of this embodiment.

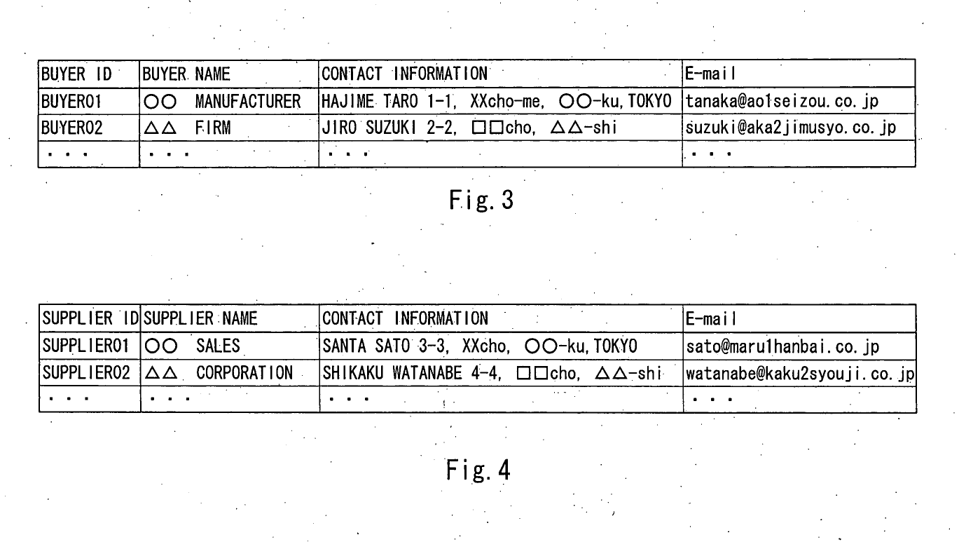

The buyer information table 172 stores information about buyers who are users of the reverse auction service. FIG. 3 shows an example of the buyer information table 172. As shown in FIG. 3, the buyer information table 172 stores information including a buyer name, a buyer ID assigned to each buyer, and buyer contact information. The buyer information is, for example, inputted by an operator through the input device 11 and stored into the internal memory 16 or the external storage device 17 through the input/output interface 13. The buyer information may be acquired from remote storage means through the communication interface 14 or it may be the data inputted by a buyer in the buyer terminal 2 and received through the communication interface 14.

The supplier information table 173 stores information about suppliers who are users of the reverse auction service. FIG. 4 shows an example of the supplier information table 173. As shown in FIG. 4, the supplier information table 173 stores information including a supplier name, a supplier ID assigned to each supplier, and supplier contact information. The supplier information is, for example, inputted by an operator through the input device 11 and stored into the internal memory 16 or the external storage device 17 through the input/output interface 13. The supplier information may be acquired from remote storage means through the communication interface 14 or it may be the data inputted by a supplier in the supplier terminal 3 and received through the communication interface 14.

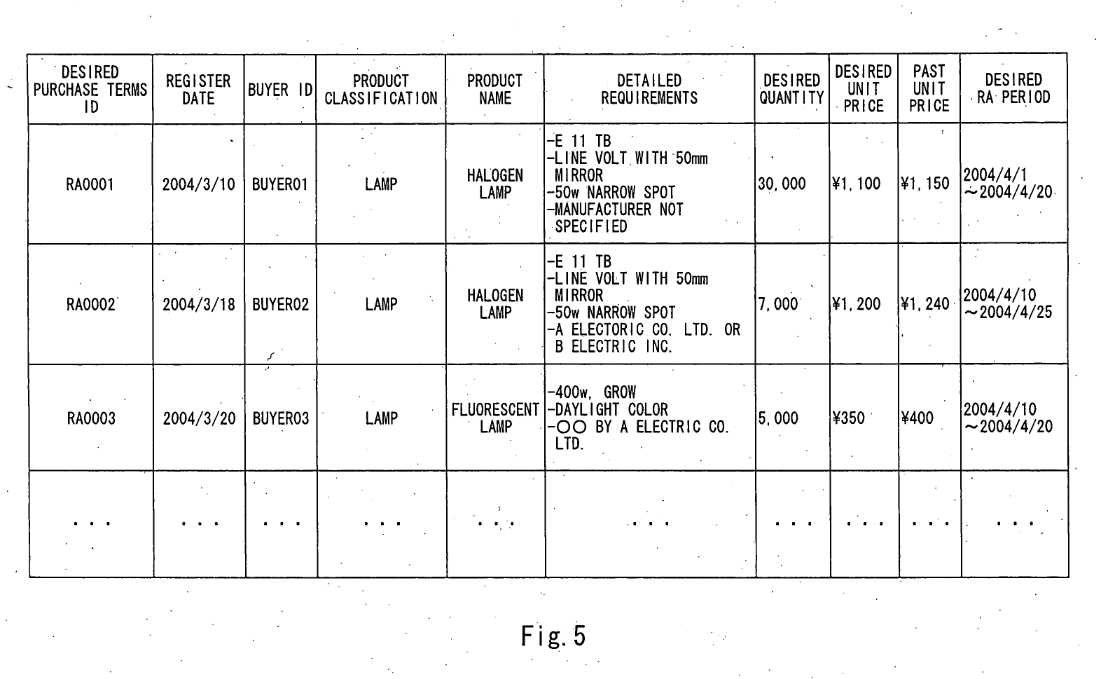

The desired purchase terms table 174 stores information contained in the desired purchase terms transmitted from the buyer terminal 2. FIG. 5 shows an example of the desired purchase terms table 174. As shown in FIG. 5, the desired purchase terms table 174 stores information including desired purchase terms ID assigned to each desired purchase terms, a buyer ID of the buyer who desires to procure, a classification of a desired procurement product, a product name, detailed requirements, desired procurement quantity, desired procurement unit price, and desired time to hold a reverse auction, which is referred to as “desired RA period” in FIG. 5, which are in association with each other. The desired purchase terms table 174 may further store past purchase unit price of the desired procurement product, presence or absence of intent for joint purchase, specification of limits of information disclosure to other buyers, and soon. The desired purchase terms are inputted from the buyer terminal 2 by a buyer who desires to procure a product, transmitted from the buyer terminal 2 to the server 1, and received through the communication interface 14 and stored in the external storage device 17, for example.

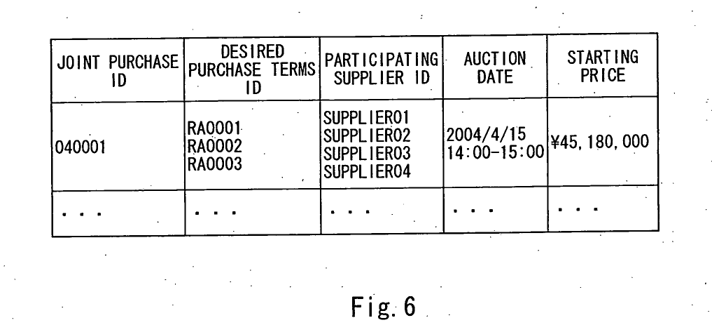

The joint purchase case table 175 stores information required to conduct joint purchase in association with each other. FIG. 6 shows an example of the joint purchase case table 175. As shown FIG. 6, the joint purchase case table 175 stores information including joint purchase ID assigned to each joint purchase case, a desired purchase terms ID related to the joint purchase, reverse auction date and starting price, in association with each other. The joint purchase case information is stored in the external storage device 17 as a result of performing the process of generating a joint purchase case, which is described later.

The buyer terminal 2 is a personal computer (PC), for example, which includes CPU, ROM, RAM, hard disk, display, keyboard, mouse, and so on. The buyer terminal 2 exchanges data with the server 1 by executing Web browser program stored in the hard disk, for example, using TCP/IP, HTTP protocol.

The supplier terminal 3 is also a PC, for example, which includes CPU, ROM, RAM, hard disk, display, keyboard, mouse, and so on. The supplier terminal 3 exchanges data with the server 1 by executing Web browser program stored in the hard disk, for example.

The network 4 is a communication network such as internet, public network, leased line, and mobile communication network.

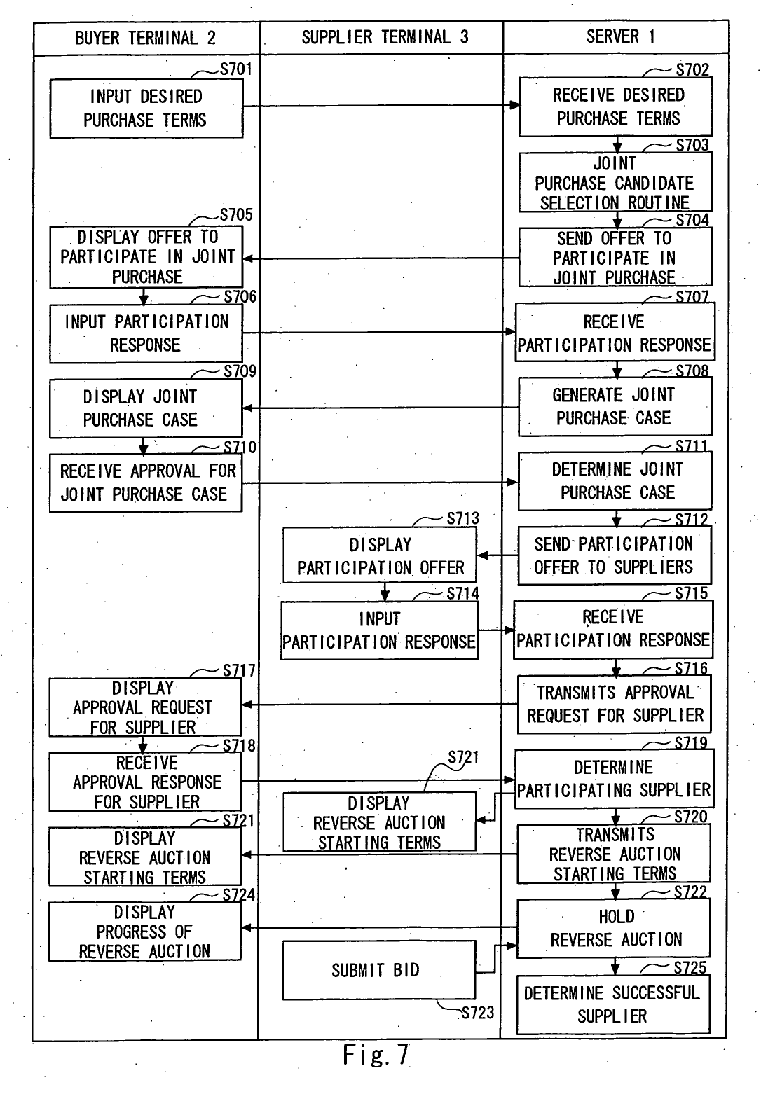

The procedure of the reverse auction is described hereafter with reference to the flow chart of FIG. 7. The process of the server 1 described below is executed according to the reverse auction execution program 171 by the CPU 15 which operates in collaboration with another hardware configuration.

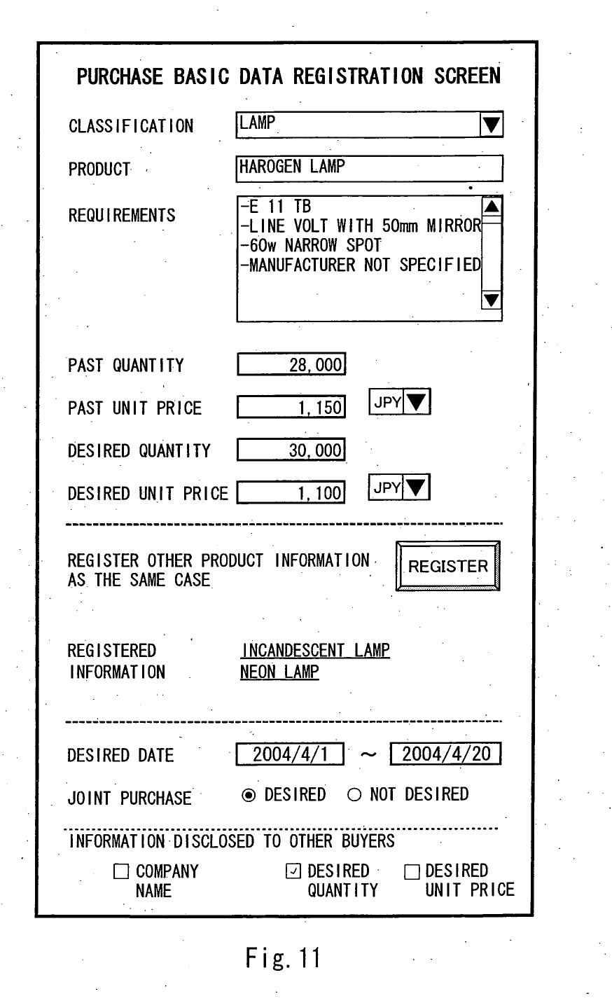

First, the buyer terminal 2 receives input of desired purchase terms by a buyer and transmits the desired purchase terms to the server 1 (S701). FIG. 11 shows an input screen of desired purchase terms displayed on the buyer terminal 2. The “classification” section indicates a material classification of a product for joint purchase. In this example, the classification “lamp” is selected for the product “halogen lamp”. A detailed specification of the product can be inputted to the “requirements” section. The “past quantity” and “past unit price” indicate information on the past purchase history of a buyer for use in determining the starting terms of reverse auction. The “desired quantity” is the number of products the buyer desires to purchase in the reverse auction, and the “desired unit price” is a unit price of a product for purchase in the reverse auction. The “desired date” is a desired period for holding the reverse auction. The screen may further include the sections for inputting presence or absence of intent for joint purchase, limits of information to be disclosed to other buyers, and so on.

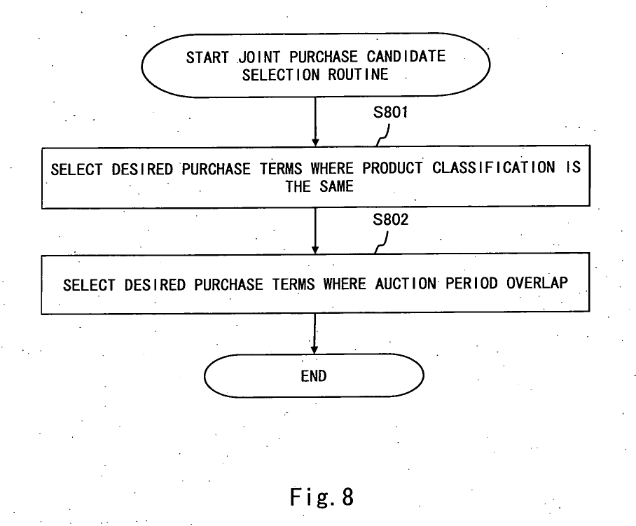

In the step S702, the server 1 receives the desired purchase terms transmitted from the buyer terminal 2 through the communication interface 13 and stores it into the desired purchase terms table 174 in the external storage device 17. In the step S703, the server 1 selects those suitable for joint purchase as joint purchase candidates from a plurality of desired purchase terms received in the step S702. An example of the joint purchase candidate selection routine is described hereafter with reference to the flow diagram of FIG. 8. The joint purchase candidate selection routine of this embodiment first compares the product classifications of the desired purchase terms stored in the desired purchase terms table 174 in the external storage device 17 and selects the desired purchase terms with the same product classification such as lamp (S801). Further, it compares “desired RA outline” of the desired purchase terms selected in the step S801 and narrows down to select the desired purchase terms in which the desired reverse auction period overlaps with each other (S802). Either the steps S801 or S802 may be carried out first.

Since the desired purchase terms thus selected are the same in product classification, it is likely to obtain the volume merit in mass procurement from the same supplier, and the product can be procured at the same time. This method allows effectively putting together the procurement cases suitable for joint purchase even if procured products are not the same.

Referring back to FIG. 7, the step S704 selects the buyer who has the desired purchase terms selected in the step S703 from the buyer ID of the desired purchase terms table 174 and transmits an invitation to participate in joint purchase. The buyer terminal 2 displays the received invitation in a display and so on (S705), inputs presence or absence of intent for joint purchase, and transmits a participation response to the server 1 (S706). The server 1 receives the participation response from the buyer terminal 2 (S707) and determines the desired purchase terms of the buyer who has returned the participation response as a final object of joint purchase.

Further, the server 1 determines a reverse auction starting price and a reverse auction date, temporality stores the price and date into the joint purchase case table 175, and transmits an approval request for the joint purchase case to the buyer terminal 2 of the buyer who is to participate in the joint purchase (S708). The reverse auction starting price may be a sum of the product of a past price and a desired quantity inputted by the buyer, for example. The reverse auction date may be arbitrarily set from a common date of the desired reverse auction periods of participating buyers.

The buyer terminal 2 displays the received approval request for joint purchase on a display or the like (S709), receives the approval of the buyer, and transmits the approval response to the server 1 (S710). After receiving the approval response, the server 1 determines this case as a joint purchase case and stores it into the joint purchase case table 175 (S711).

After that, in order to collect suppliers to participate in joint purchase, the server 1 transmits a notice of an invitation to participate in joint purchase to the supplier terminal 3 (S712) At this time, the server 1 also supplies to the supplier terminal 3 the information about the reverse auction case such as the reverse auction date and starting price stored in the joint purchase case table 175 and a desired product, detailed requirements, desired quantity stored in the desired purchase terms table 174 associated by the desired purchase terms ID. The information about the reverse auction case may be accessed by the supplier who has received the notice of an invitation to participate in the joint purchase through the supplier terminal 3 to the server 1. The supplier terminal 3 displays the received invitation in a display or the like (S713) so that a supplier inputs a participation response, and transmits the response to the server 1 (S714). The server 1 temporarily stores the supplier who has returned the participation response into the joint purchase case table 175 (S715)

Then, the server 1 transmits an approval request for the supplier who has returned the participation response to the buyer terminal 2 of the buyer to participate in the joint purchase (S716) The buyer terminal 2 displays the request on the display or the like so that the buyer inputs an approval response, and transmits the approval response to the server 1 (S717 and S718). Upon receiving the approval response, the server 1 determines the participating supplier and stores it into the joint purchase case table 175 (S719).

The process up to the step S719 determines the starting terms of the joint purchase reverse auction. The server 1 transmits the determined starting terms to the buyer terminal 2 and the supplier terminal 3 (S720 and S721), holds the reverse auction according to the reverse auction date stored in the joint purchase case table 175 and determines a successful supplier (S722 to S725).

Though the above description is given on the case where an object of procurement in the reverse auction is a product, it is the same for the case where an object of procurement is service such as manpower dispatching and entrusted business. If the server 1, the buyer terminal 2, and the supplier terminal 3 operate according to the operation flow described in the foregoing, it is possible to generate a joint purchase case upon occurrence of a purchase desire by a buyer and effectively put together the cases based on the identity and similarity of a product or service classification even if a product or service to be procured is different, thereby conducting the joint purchase reverse auction.

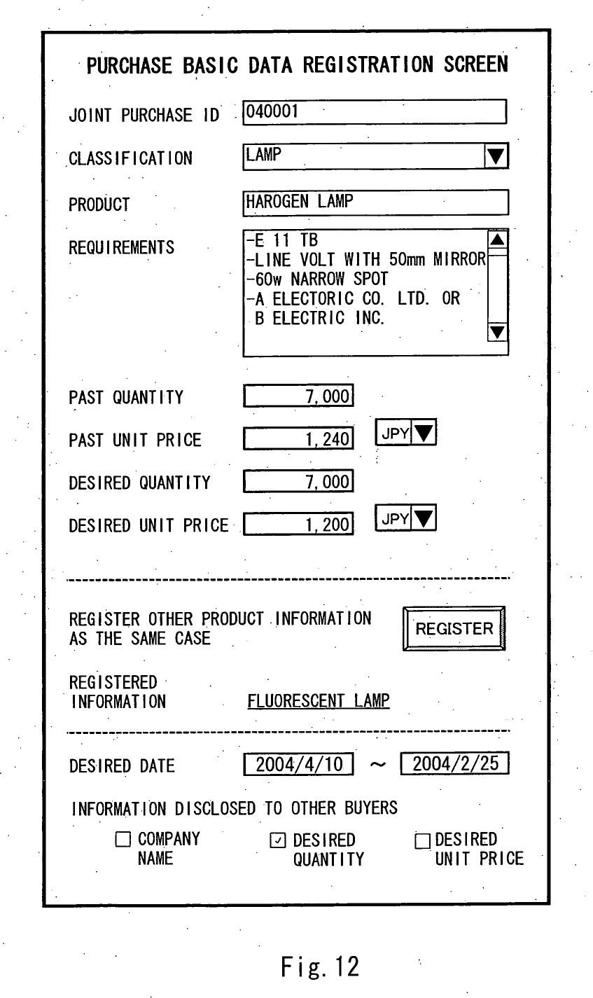

Further, though the above flow selects the buyers with similar desired purchase terms and transmits an invitation to participate in joint purchase to the buyer terminal 2 of the selected buyers, it is also possible to transmit the invitation to the buyer terminals 2 of all the registered buyers. In this case, when receiving a response from a buyer who desires to participate, it is preferred to a screen as shown in FIG. 12 may be displayed for the buyer terminal 2 so as to prompt a buyer to input desired purchase terms, for example. By making association with a joint purchase ID, the inputted desired purchase terms are stored in the desired purchase terms table 174 of the external storage, device 17 of the server 1 as new desired purchase terms in association with the joint purchase case table 175. Transmitting an invitation to participate in joint purchase to many buyers allows spurring demand of potential buyers, thereby increasing a possibility to effectively conduct joint purchase when the number of participating buyers is expected to be small.

Furthermore, though this embodiment describes the case where the reverse auction execution program 171 is stored in the external storage device 17 such as a hard disk, the program may be stored in a variety of storage media or transmitted through a communication medium. The storage media include a flexible disk, hard disk, magnetic disk, magnetic optical disk, CD-ROM, DVD, ROM cartridge, RAM memory cartridge with battery backup, flash memory cartridge, nonvolatile RAM cartridge, and soon, for example. The communication media include wired communication media such as a telephone line and wireless communication media such as a microwave line, including internet.

Second Embodiment

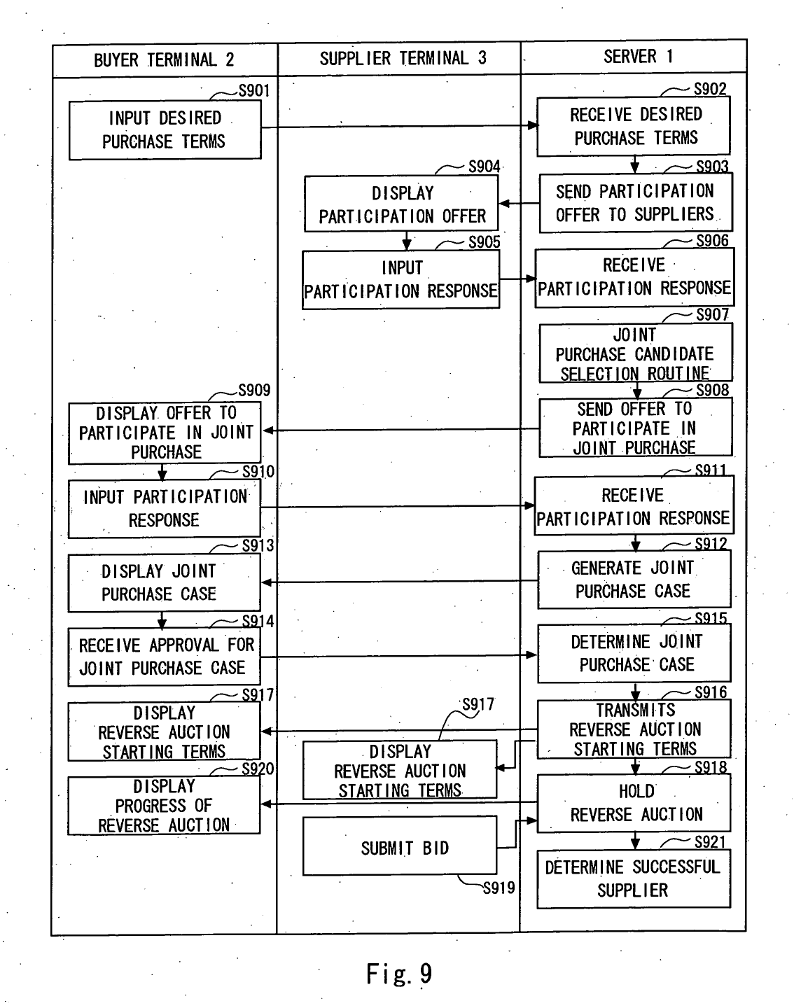

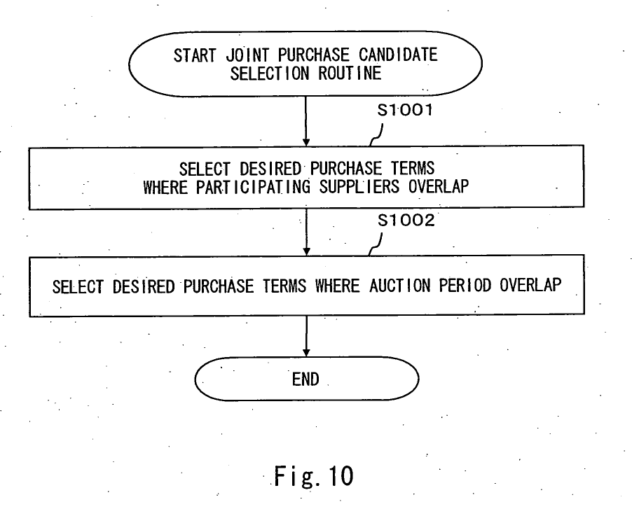

The reverse auction system of a second embodiment is different from that of the first embodiment in the reverse auction process flow. After receiving desired purchase terms from the buyer terminal 2, the server 1 gives an invitation to participate in reverse auction to suppliers prior to the desired purchase terms selection routine. Then, after receiving a participation response from the supplier, the server 1 performs the desired purchase terms selection routine in accordance with overlap of the suppliers who intend to participate in the reverse auction. This is different from the reverse auction process flow of the first embodiment described with reference to FIGS. 7 and 8. The reverse auction process flow of this embodiment is described hereafter with reference to FIG. 9 and 10. The overall system scheme and the structures of the server 1, the buyer terminal 2, and the supplier terminal 3 are the same as those in the first embodiment, and thus not described below.

Firstly, just like the reverse auction of the first embodiment, the buyer terminal 2 accepts input of desired purchase terms by a buyer and transmits the inputted desired purchase terms to the server 1 (S901). The server 1 receives the desired purchase terms transmitted from the buyer terminal 2 through the communication interface 13 and stores it into the desired purchase terms table 174 of the external storage device 17 (S902).

Then, in this embodiment, the server 1 transmits an invitation to participate in reverse auction for the desired purchase terms to the supplier terminals 3 with reference to the desired purchase terms stored in the desired purchase terms table 174 (S903). At this time, the server 1 also transmits to the supplier terminal 3 information about the reverse auction case such as the desired product, detailed requirements, desired quantity, and desired reverse auction period stored in the desired purchase terms table 174, and reverse auction starting price determined from a product of a past unit price and a desired quantity. The information about the reverse auction case may be accessed by the supplier who has received the participation invitation to in the joint purchase through the supplier terminal 3 to the server 1.

The supplier terminal 3 displays the received participation invitation on a display or the like (S904) so that a supplier inputs a participation response and transmits it to the server 1 (S905). The server 1 receives the participation response from the supplier terminal 3 (S906). It is preferred to store the supplier ID of the supplier who has returned a participation response into the desired purchase terms table 174 in association with the desired purchase terms ID.

The next step S907 selects those suitable for joint purchase as joint purchase candidates from a plurality of desired purchase terms received in the step S902. An example of the joint purchase candidate selection routine is described hereafter with reference to the flow diagram of FIG. 10. The joint purchase candidate selection routine of this embodiment first selects the desired purchase terms with the same supplier ID of the supplier intending to participate, which is added to the desired purchase terms table 174 in the external storage device 17 (S1001). Further, it compares the “desired RA outline” of the desired purchase terms selected in the step S1001 and narrows down to select the desired purchase terms in which the desired reverse auction period overlaps with each other (S1002).

Since the desired purchase terms thus selected are the same in the supplier who intends to participate in the reverse auction, it is likely to obtain the volume merit in mass procurement by exercising joint purchase, and the product can be procured at the same time. This method allows effectively putting together the procurement cases in which buyers intending to participate overlap even if a procured product is not the same.

The process after the step S908, which determines the buyers who participate in the joint purchase (S908 to S911), sets a date to hold the joint purchase reverse auction, participating buyers and participating suppliers (S912 to S915), and holds the reverse auction and determines a successful supplier (S916 to S921), is the. same as the corresponding process in the first embodiment and thus not described here.

If the server 1, the buyer terminal 2, and the supplier terminal 3 operate according to the process flow described above, it is possible to generate a joint purchase case upon occurrence of a desire to purchase a product/service by a buyer and effectively put together the cases in accordance with the overlap of the suppliers who intend to participate in the reverse auction even if a product or service to be procured is different, thereby conducting the joint purchase reverse auction.

Third Embodiment

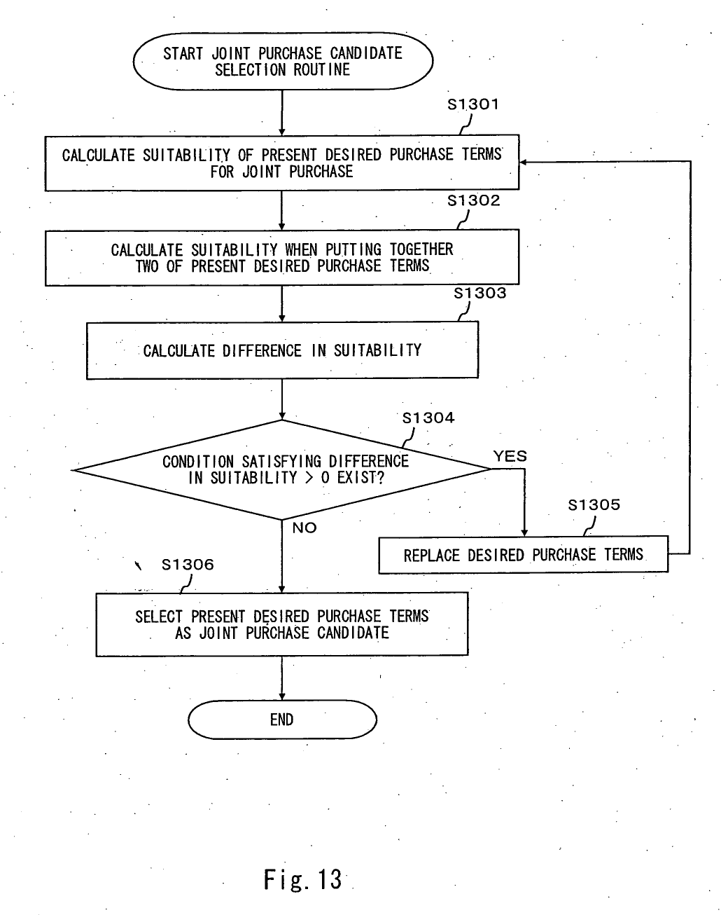

A third embodiment describes the case where the joint purchase candidate selection routine described in the second embodiment is more detailed. FIG. 13 shows the process flow of the joint purchase candidate selection routine of this embodiment. The joint purchase candidate selection routine of this embodiment defines suitability that indicates how suitable it is for joint purchase to find a combination of desired purchase terms according to the suitability, and determines the desired purchase terms included in the obtained combination as a joint purchase candidate.

First, the step S1301 calculates the suitability of each present desired purchase terms. In the initial stage of the loop process performed in this routine, each desired purchase terms before combined are the present desired purchase terms. The suitability may be defined by three parameters of presence or absence of intent for joint purchase, purchase amount volume, and the number of participating suppliers, for example, in which the maximum points of each parameter are 10 and total maximum points are 30. Each parameter is expressed numerically as follows, for example. Presence or absence of intent for joint purchase may be indicated by 10 points. where the intent exists or 0 point where no intent exists. The purchase amount volume may be indicated by 5 points where the number of combined desired purchase terms is two, 7.5 points where it is three, 10 points where it is four or more, and 0 point where it is not combined. Further, the number of participating suppliers may be represented by the parameter (nc/n1)*10 where a reduction ratio (nc/n1) that is the number of suppliers (nc) who can participate when combining desired purchase terms, divided by the number of suppliers (n1) who can participate when alone, multiplied by 10.

Then, the step S1302 calculates the suitability when combining two of the present desired purchase terms. This corresponds to calculate the suitability assuming the case of making joint purchase. The step S1303 finds the remainder when the individual suitability calculated in S1301 is subtracted from the combinational suitability calculated in S1302. The step S1304 determines conditions by a difference in the suitability calculated in S1303. If a difference in suitability is greater than 0, the process updates data by setting the maximum one of the combinational desired purchase terms as the present desired purchase terms and the process returns to the step S1301 (S1305). On the other hand, if a difference in suitability is equal to or smaller than 0, the process selects the combinational desired purchase terms as joint purchase candidates from the present desired purchase terms while determining individual desired purchase terms as an individual purchase case which is not for joint purchase, thereby ending the joint purchase candidate selection routine.

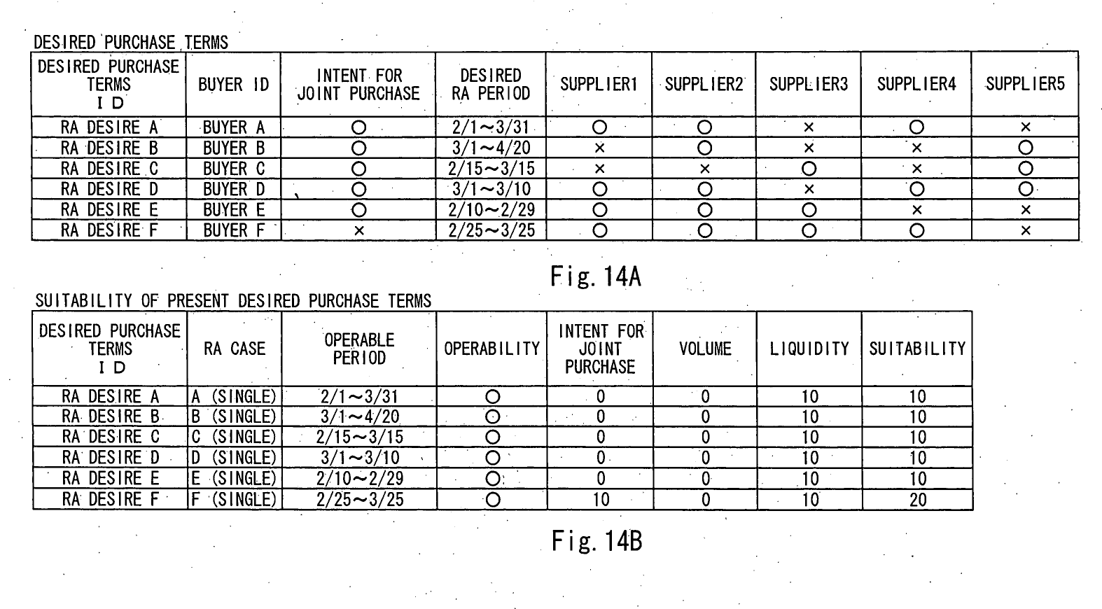

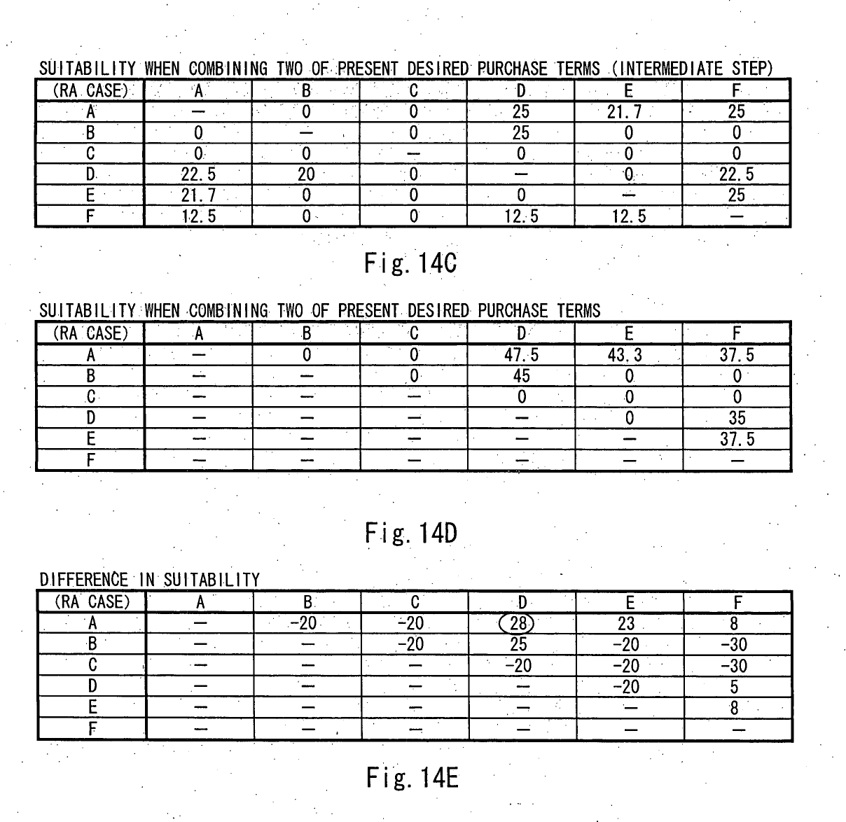

A specific example of the joint purchase candidate selection routine is described hereafter with reference to FIGS. 14A to 14E, 15A to 15E, and 16A to 16E. FIG. 14A to 14E shows the first sequence of the loop in this routine. FIG. 14A is a table indicating individual desired purchase terms. It shows a list of presence or absence of intent for joint purchase, desired reverse auction period, and participatable suppliers for the desired purchase terms of six buyers A to F. FIG. 14B is a table showing a calculation result of the suitability for the present desired purchase terms, which corresponds to the step S1301, which is the suitability for individual desired purchase terms. The item “operability” indicates the operability of joint purchase when the desired reverse auction period overlaps. The mark “∘” indicates that joint purchase is possible. FIG. 14D is a table showing the suitability for the combinational present desired purchase terms, which corresponds to the step S1303. FIG. 14C shows the intermediate step when calculating the suitability for the combinational terms. FIG. 14E calculates a difference in the suitability, which corresponds to the step S1303. Since a difference in the suitability is maximum (28 points) when combining the cases A and D, the data is updated to set the combination of the cases. A and D to the present desired purchase terms. After that, the process performs the second sequence.

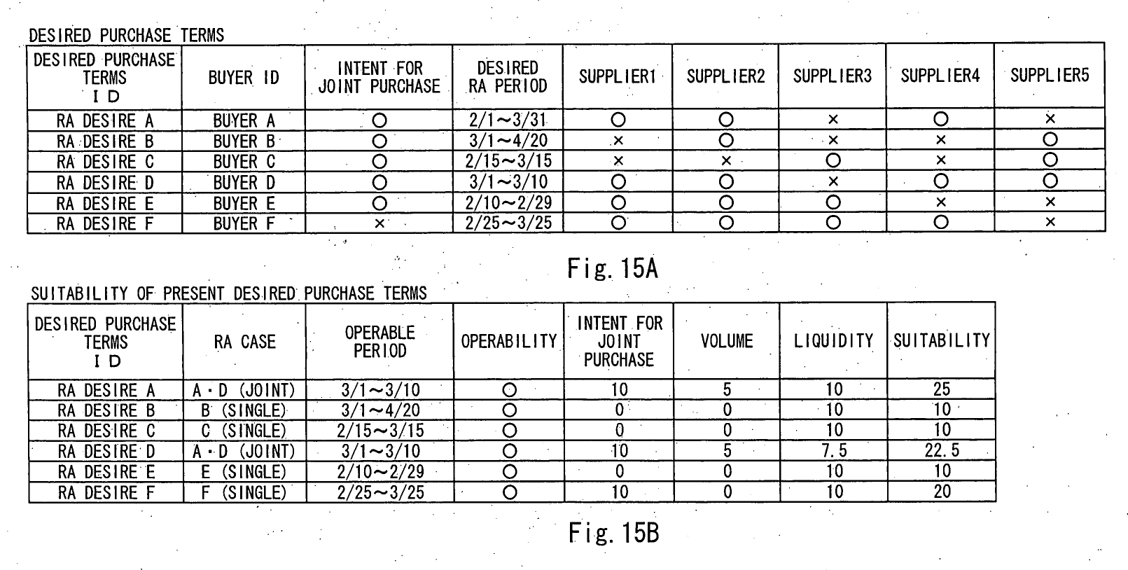

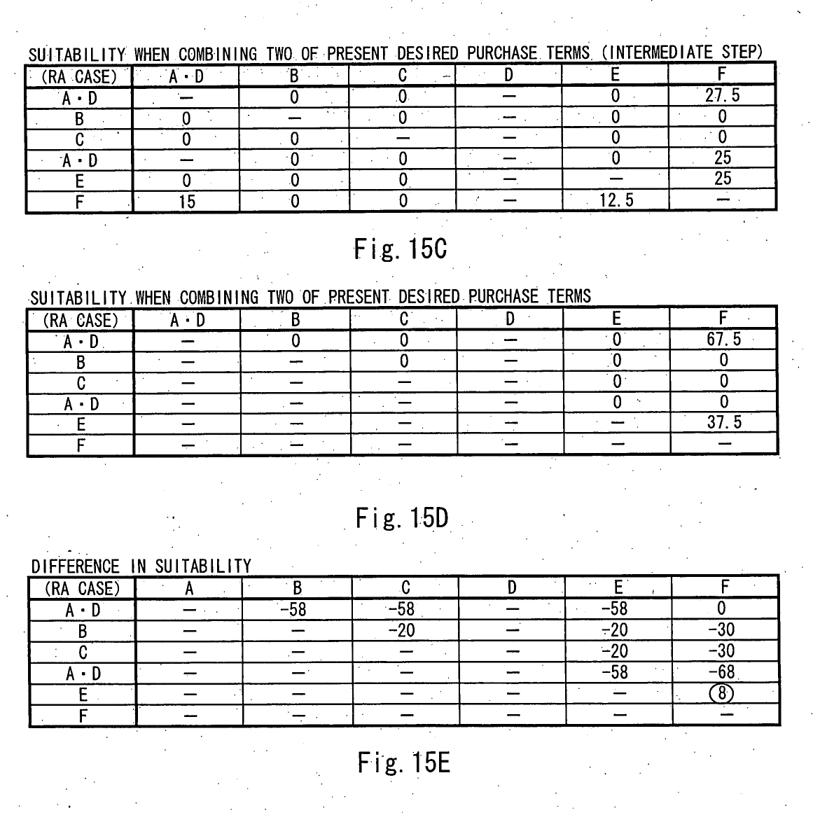

FIGS. 15A to 15E show the second sequence of the loop in this routine. Just like FIGS. 14A to 14E, FIG. 15B indicates the suitability for the present desired purchase terms, which corresponds to the step S1301, and FIG. 15C indicates the intermediate step when calculating the suitability in combination. FIG. 15D indicates the suitability for the combinational present desired purchase terms, which corresponds to the step S1302. FIG. 15E indicates a difference in suitability, which corresponds to the step S1303. Since the second sequence still includes a difference in suitability being greater than 0 as shown in FIG. 15E, the process updates data to set the combination of the cases E and F, which has the maximum difference, to the present desired purchase terms and then performs the third sequence.

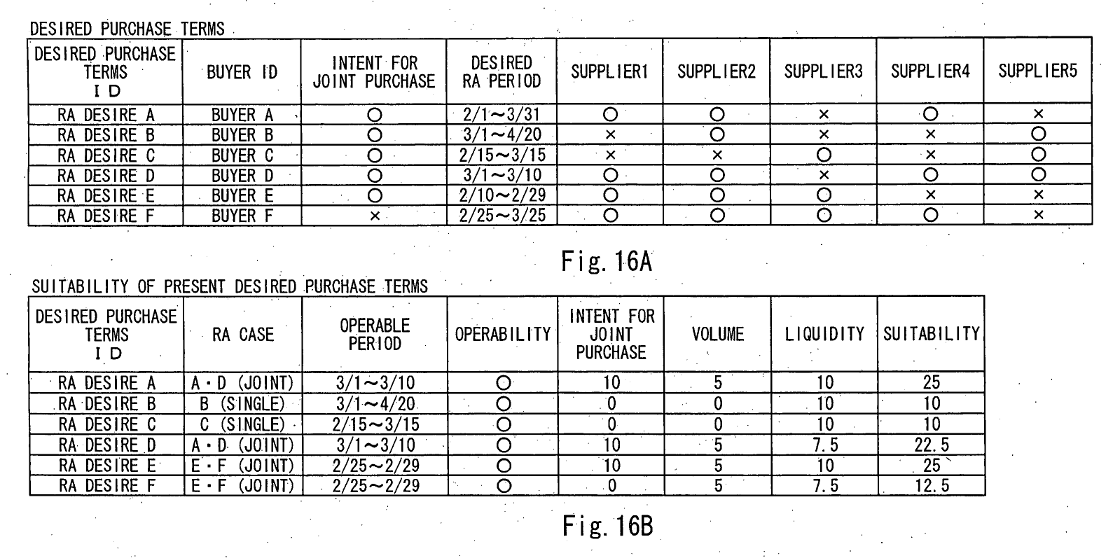

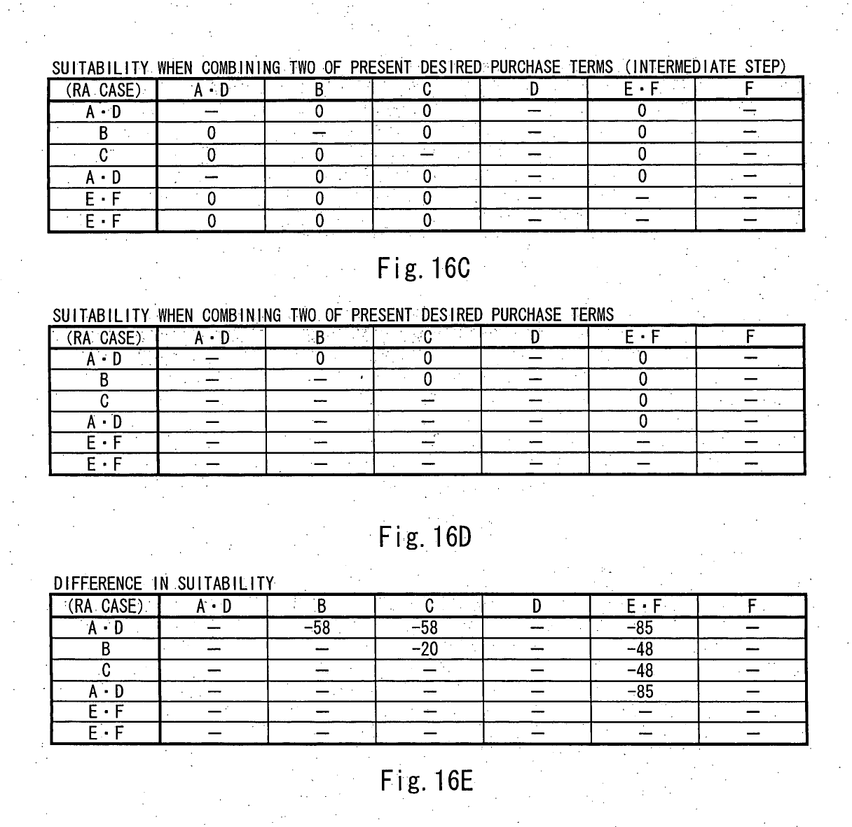

FIGS. 16A to 16E show the third sequence of the loop in this routine. Just like FIGS. 15A to 15E, FIG. 16B indicates the suitability for the present desired purchase terms, which corresponds to the step S1301, and FIG. 16C indicates the intermediate step when calculating the suitability in combination. FIG. 16D indicates the suitability for the combinational present desired purchase terms, which corresponds to the step S1302. FIG. 16E indicates a difference in suitability, which corresponds to the step S1303. Since the third sequence does not include a difference in suitability being greater than 0 as shown in FIG. 16E, this combination is selected as joint purchase candidates and this routine thereby ends. Specifically, the cases A and D are selected as joint purchase candidates, the cases E and F are selected as other joint purchase candidates, and the cases B and C are determined as individual purchase.

Expressing the parameters for determining joint purchase candidates numerically and evaluating the parameter values allows selection of cases suitable for joint purchase more specifically.

Other Embodiments

The joint purchase candidate selection routine of the above embodiments is just an example, and it may be varied in different ways. For example, the joint purchase candidate selection routine of the first embodiment may select the desired purchase terms in the range of the similar product classification or select all the desired purchase terms in which the desired reverse auction period overlaps regardless of the product classification. Further, it is possible to express numerically the items effective for selecting joint purchase candidate including the item of desired purchase terms, such as overlap of participating suppliers, overlap of desired reverse auction period, and total prosecution quantity and evaluate the suitability for joint purchase of each combination of desired purchase terms, thereby selecting the most suitable combination. The most suitable combination may be selected by various methods known as optimization techniques.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

1. A reverse auction method implemented by a server connected to a plurality of buyer terminals and a plurality of supplier terminals through a network, the method comprising:
selecting desired purchase terms as candidates for joint purchase from desired purchase terms received from the plurality of buyer terminals;
transmitting an invitation to participate in joint purchase to a buyer terminal of a buyer corresponding to at least the selected desired purchase terms; and
receiving a participation response to the invitation from a buyer terminal of a buyer intending to participate in reverse auction and determining a combination of buyers participating in joint purchase according to the participation response.

2. The reverse auction method of claim 1, wherein
the desired purchase terms at least include information indicating a classification of a product/service and information indicating a desired time to hold a reverse auction, and
the desired purchase terms are selected as candidates for joint purchase according to the information indicating a classification of a product/service and the information indicating a desired time to hold a reverse auction.

3. The reverse auction method of claim 1, wherein
the desired purchase terms at least include information indicating a classification of a product/service, and
desired purchase terms with the same product/service classification are selected as candidates for joint purchase.

4. The reverse auction method of claim 1, wherein
the desired purchase terms at least include information indicating a desired quantity of a product/service, and
desired purchase terms are selected as candidates for joint purchase according to the information indicating a quantity of a product/service so as to increase prosecution quantity in joint purchase.

5. The reverse auction method of claim 1, further comprising:
transmitting the desired purchase terms received form the plurality of buyer terminals to the supplier terminals and receiving a participation response of a supplier intending to participate in reverse auction from the supplier terminals,
wherein desired purchase terms are selected as candidates for joint purchase according to the participation response of the supplier.

6. The reverse auction method of claim 1, wherein the invitation to participate in joint purchase is transmitted to all the buyer terminals.

7. The reverse auction method of claim 1, further comprising:
transmitting an approval request for joint purchase to a buyer terminal of a buyer included in the combination of buyers participating in joint purchase; and
receiving an approval for joint purchase from the buyer terminal and updating the combination of buyers participating in joint purchase according to the approval.

8. A computer program product for causing a computer connected to a plurality of buyer terminals and a plurality of supplier terminals through a network to execute a process of reverse auction, the computer program product including a computer readable medium storing a program code, the program code comprising:
a first program code selecting desired purchase terms as candidates for joint purchase from desired purchase terms received from the plurality of buyer terminals;
a second program code transmitting an invitation to participate in joint purchase to a buyer terminal of a buyer corresponding to at least the desired purchase terms selected by the first program code; and
a third program code determining a combination of buyers participating in joint purchase according to a participation response to the invitation received from a buyer terminal of a buyer intending to participate in reverse auction.

9. The computer program product of claim 8, wherein
the desired purchase terms at least include information indicating a classification of a product/service and information indicating a desired time to hold a reverse auction, and
the second program code selects desired purchase terms as candidates for joint purchase according to the information indicating a classification of a product/service and the information indicating a desired time to hold a reverse auction.

10. The computer program product of claim 8, wherein
the desired purchase terms at least include information indicating a classification of a product/service, and
the second program code selects desired purchase terms with the same product/service classification as candidates for joint purchase.

11. The computer program product of claim 8, wherein
the desired purchase terms at least include information indicating a desired quantity of a product/service, and
the second program code selects desired purchase terms as candidates for joint purchase according to the information indicating a quantity of a product/service so as to increase prosecution quantity in joint purchase.

12. The computer program product of claim 8, further comprising:
a program code transmitting the desired purchase terms received form the plurality of buyer terminals to the supplier terminals and receiving a participation response of a supplier intending to participate in reverse auction from the supplier terminals,
wherein the second program code selects desired purchase terms as candidates for joint purchase according to the participation response of the supplier.

13. The computer program product of claim 8, further comprising:
a program code transmitting an approval request for joint purchase to a buyer terminal of a buyer included in the combination of buyers participating in joint purchase; and
a program code receiving an approval for joint purchase from the buyer terminal and updating the combination of buyers participating in joint purchase according to the approval.

14. A server connected to a plurality of buyer terminals and a plurality of supplier terminals through a network and implementing reverse auction, the server comprising:
a joint purchase candidate selection unit selecting desired purchase terms as candidates for joint purchase from desired purchase terms received from the plurality of buyer terminals;
an invitation transmission unit transmitting an invitation to participate in joint purchase to a buyer terminal of a buyer corresponding to at least the desired purchase terms selected by the joint purchase candidate selection unit; and
a determination unit determining a combination of buyers participating in joint purchase according to a participation response to the invitation received from a buyer terminal of a buyer intending to participate in reverse auction.

15. The server of claim 14, wherein
the desired purchase terms at least include information indicating a classification of a product/service and information indicating a desired time to hold a reverse auction, and
the joint purchase candidate selection unit selects desired purchase terms as candidates for joint purchase according to the information indicating a classification of a product/service and the information indicating a desired time to hold a reverse auction.

16. The server of claim 14, wherein
the desired purchase terms at least include information indicating a classification of a product/service, and
the joint purchase candidate selection unit selects desired purchase terms with the same product/service classification as candidates for joint purchase.

17. The server of claim 14, wherein
the desired purchase terms at least include information indicating a desired quantity of a product/service, and
the joint purchase candidate selection unit selects desired purchase terms as candidates for joint purchase according to the information indicating a quantity of a product/service so as to increase prosecution quantity in joint purchase.

18. The server of claim 14, further comprising:
a program code transmitting the desired purchase terms received form the plurality of buyer terminals to the supplier terminals and receiving a participation response of a supplier intending to participate in reverse auction from the supplier terminals,
wherein the joint purchase candidate selection unit selects desired purchase terms as candidates for joint purchase according to the participation response of the supplier.

19. The server of claim 14, further comprising:
a program code transmitting an approval request for joint purchase to a buyer terminal of a buyer included in the combination of buyers participating in joint purchase; and
a program code receiving an approval for joint purchase from the buyer terminal and updating the combination of buyers participating in joint purchase according to the approval.
